(19) United States
(12) Patent Application Publication
(10) Pub. No.: US 2005/0012319 A1
(43) Pub. Date: Jan. 20, 2005

(54) Load limiting structure for vehicle occupant restraint system

(76) Inventor: Kurt Schulz, Harper Woods, MI (US)

Correspondence Address: KEY SAFETY SYSTEMS, INC.;PATENT DEPARTMENT, 5300 ALLEN K BREED HIGHWAY, LAKELAND, FL, 33811-1130, US

(21) Appl. No.: 10/617,715

(22) Filed: Jul. 14, 2003

(51) Int. Cl. B60R 22/00; B60R 22/48; B60R 22/28

(52) U.S. Cl. 280/805; 280/808; 280/801.1

(57) ABSTRACT

A new and useful load-limiting device for a vehicle occupant restraint is provided. The load-limiting device comprises a longitudinal, load-limiting member connected between the vehicle occupant restraint and an anchor point such as a vehicle seat or a structural part of the vehicle. The load-limiting member is configured to deform plastically to dissipate forces applied to the load-limiting member by the vehicle occupant during a crash. Moreover, according to the preferred embodiments, the design of the load-limiting member provides a new and useful form of plastic deformation to dissipate forces applied to the load-limiting member by the vehicle occupant restraint. Specifically, in one embodiment the load-limiting member comprises a deformable strip with a pattern of perforations disposed in staggered rows extending transverse to the strip. In another embodiment the load-limiting member comprises a deformable tube with a pattern of perforations disposed in staggered rings extending about the central axis of the tube. The configuration of the load-limiting member provides a plurality of beam like segments that deform progressively, and with bending beam characteristics, to dissipate forces applied to the load-limiting member by the vehicle occupant during a crash.

### FIELD OF THE INVENTION

The present invention relates to a load limiting structure for a vehicle occupant restraint.

### BACKGROUND OF THE INVENTION

A typical occupant restraint system for a vehicle comprises a belt (often comprising a lap belt component and a shoulder belt component) anchored to structural parts of the vehicle such as the floor, a pillar such as a B pillar or to a seat frame. Where the restraint system includes a shoulder belt portion (also referred to herein as a “shoulder harness”), the shoulder harness typically extends through a web guide that is coupled to a structural part of the vehicle such as the B-pillar or the seat frame. The restraint system further includes a retractor, often called an “ELR or emergency locking retractor”, which is designed to take up or provide a controlled amount of slack in the belt system when the belt system has been fitted about a vehicle occupant. The retractor allows payout of belt (typically the shoulder belt) in response to movement of the vehicle occupant during normal vehicle operation. However, at the onset of a crash, the retractor becomes automatically locked, to restrain further belt payout, and to keep the vehicle occupant in her or his seat.

The prior art teaches vehicle occupant restraint systems with tensioning devices, also referred to as “belt tighteners” and/or load-limiting devices, to better control the manner in which force(s) are applied to a vehicle occupant during a crash. Specifically, a tensioning device applies a positive force to the belt immediately at the onset of a crash, to tighten the restraint against the vehicle occupant. A load-limiting device acts between the belt or retractor and a structural part of the vehicle and dissipates force applied to a vehicle occupant during a crash. When a tensioning device/belt tightener and load-limiting device are combined into a vehicle occupant restraint system, the tensioning device reduces residual slack in the seat belt system and the load-limiting device controls the subsequent dissipation of force on a vehicle occupant during the crash.

U.S. Pat. Nos. 6,183,015 B1, 6,196,589 B1 and 6,209,916 B1 teach known types of load limiting devices. In those patents a load limiting device includes a hydraulic piston with fluid chambers on its opposite sides, and a flow control system for controlling flow to one or both chambers, to control movement of the piston under forces applied to the piston by a vehicle occupant restraint system. Moreover, in those patents a crush tube is provided, and is crushed by the piston as the piston moves in one direction in the fluid chamber, to further dissipate forces applied to the piston by a vehicle occupant restraint system.

The present invention provides a new and useful concept for a load-limiting device for a vehicle occupant restraint system. The load-limiting device comprises a longitudinal, load-limiting member connected between the vehicle occupant restraint and a structural part of the vehicle. The load-limiting member is configured to deform plastically to dissipate forces applied to the vehicle occupant during a crash.

According to the preferred embodiments, the design of the load-limiting member provides a new and useful form of plastic deformation to dissipate forces applied to the vehicle occupant. Specifically, the configuration of the load-limiting member provides a plurality of segments that deform with bending beam characteristics, to dissipate forces applied to the vehicle occupant during a crash.

These and other features of the present invention will become further apparent from the following detailed description and the accompanying drawings.

### BRIEF DESCRIPTION OF THE DRAWINGS

FIG. 1 is a schematic view of a vehicle occupant restraint system with a load-limiting device formed according to the principles of the present invention.

FIG. 1A is a fragmentary view of a load limiting device according to FIG. 1 coupled with the web guide of the vehicle occupant restraint and with an anchor point on the vehicle.

FIG. 2 is a perspective view of a load limiting member according to one embodiment of the present invention.

FIGS. 2A-2C are schematic fragmentary illustrations of the manner in which a load limiting member according to FIG. 2 deforms as it dissipates forces applied to a vehicle occupant during a crash.

FIG. 3 is a perspective view of a load-limiting member generally similar to FIG. 2, but with different size perforations.

FIG. 4 is a fragmentary view of another configuration of a load limiting device according to the present invention coupled with a web guide of a vehicle occupant restraint and with an anchor point on a vehicle.

FIG. 5 is a perspective view of the deformable portion of the load-limiting device of FIG. 5.

FIGS. 5A-5C are schematic fragmentary illustrations of the manner in which a load limiting member according to FIG. 5 deforms as it dissipates forces applied to a vehicle occupant during a crash.

### DETAILED DESCRIPTION OF THE INVENTION

The present invention relates to a load-limiting device for a vehicle occupant restraint, which dissipates forces applied to a vehicle occupant during a crash. The principles of the present invention are applicable to different configurations for a vehicle occupant restraint, and are described below in connection with a belt that includes a lap belt and shoulder harness (which is often referred to as a three-point safety restraint system). It will be clear to those in the art that the principles of the invention are applicable to a variety of vehicle occupant restraints (e.g. front and rear seat belts, etc) and are applicable to vehicle occupant restraints anchored to various structural parts of a vehicle (e.g. a vehicle floor, B-pillar, vehicle seat, etc).

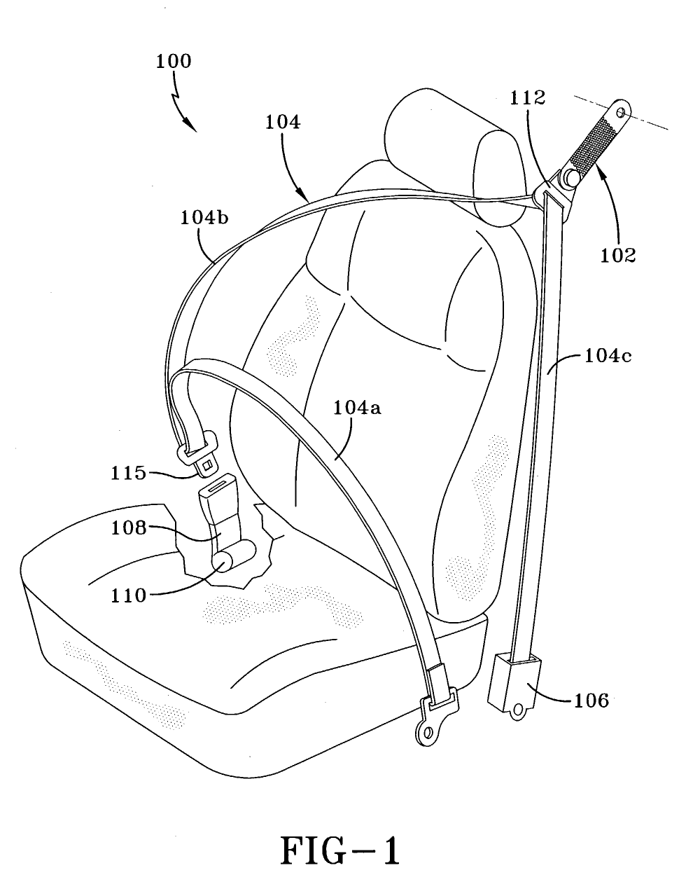

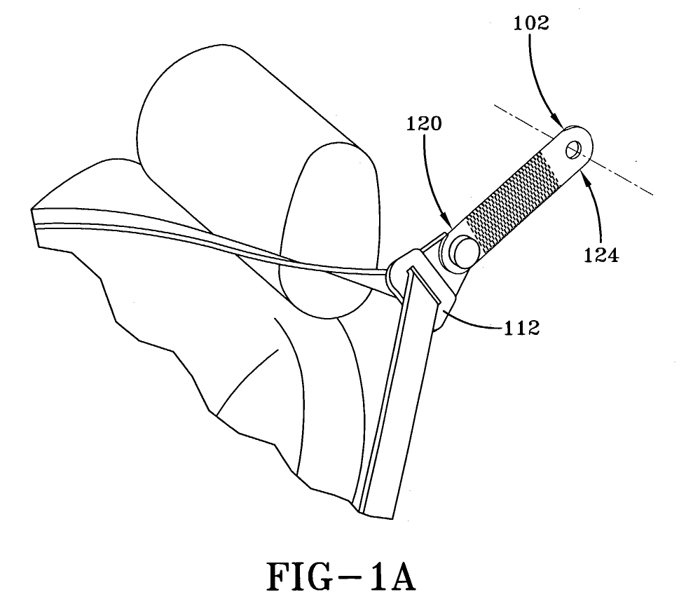

FIGS. 1 and 1A schematically illustrate a vehicle occupant restraint system 100, which incorporates a load-limiting device 102 according to the present invention. The vehicle occupant restraint system is belt 104 designed to fit a vehicle passenger. The belt 104 comprises a lap belt component 104a and a shoulder belt component 104b. The belt also includes a vertical component 104c that is attached to a retractor located inside a plastic trim 106. The retractor is coupled to a structural part of a vehicle (e.g. the vehicle floor or the base of the vehicle B pillar). Part of the belt is wound about a spool of the retractor, which allows controlled payout of the belt as the belt is being fitted about a vehicle occupant. A buckle 108 is coupled with an anchor 110 that is secured to a structural part of the vehicle (e.g. the floor of the vehicle). The parts of the belt forming the shoulder component 104b and the vertical component 104c extends through a web guide, or turning loop, 112 that is coupled to a structural part of a vehicle (e.g. the vehicle B-pillar or the roof rail of the vehicle) by the load-limiting device 102 constructed according to the principles of the present invention. A tongue 115 is connected with the belt 104, and is designed to be manually coupled to the buckle 108 by the vehicle occupant. The tongue 115 separates the belt 104 into the lap and shoulder belt components 104a, 104b, but those in the art will recognize that the restraint system can also comprise separate lap belt and shoulder belt components with separate, respective retractors.

During normal vehicle operation, the retractor allows some limited amount of belt payout, if the vehicle occupant shifts position in the vehicle. However, at the onset of a vehicle crash, the retractor locks and prevents further belt payout, to restrain the vehicle occupant during the crash. The load-limiting device 102 is designed to absorb kinetic energy of a vehicle occupant as the vehicle occupant loads the belt during a crash. Specifically, when a vehicle occupant loads the belt during a crash, force and energy is applied by the vehicle occupant to the belt, and it is that force and energy that is absorbed by the load-limiting device 102.

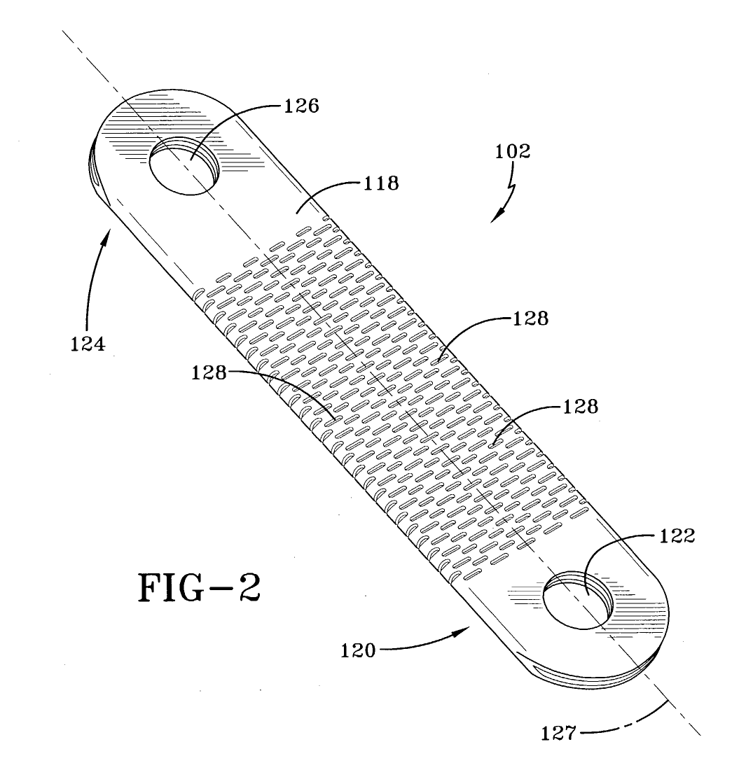

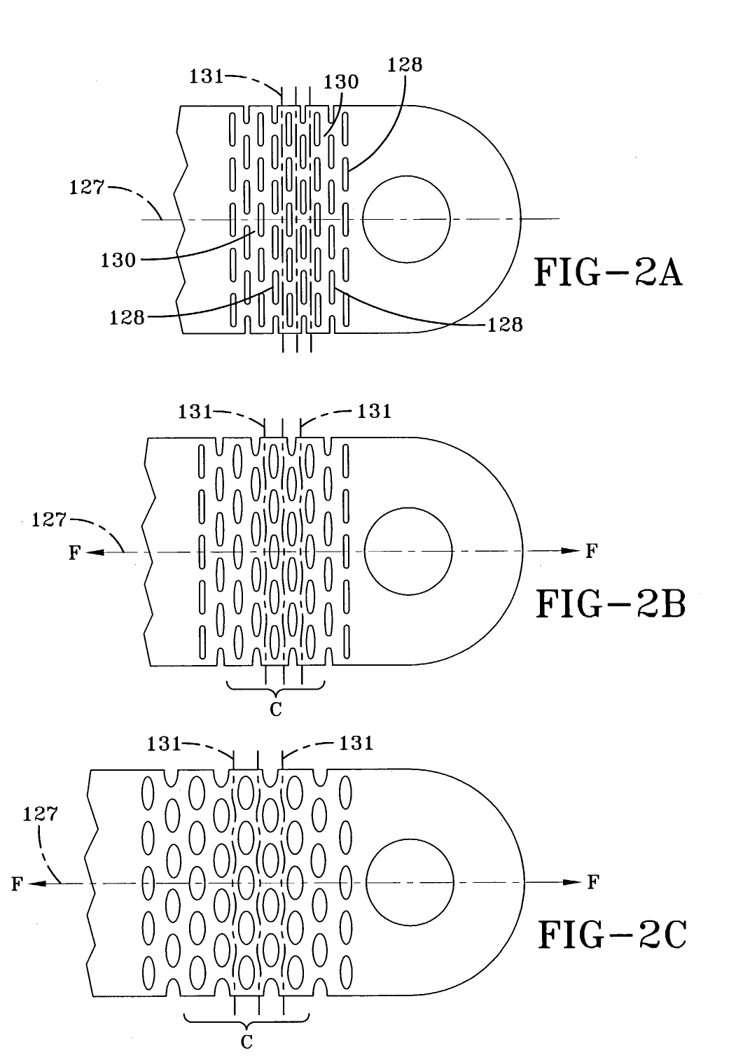

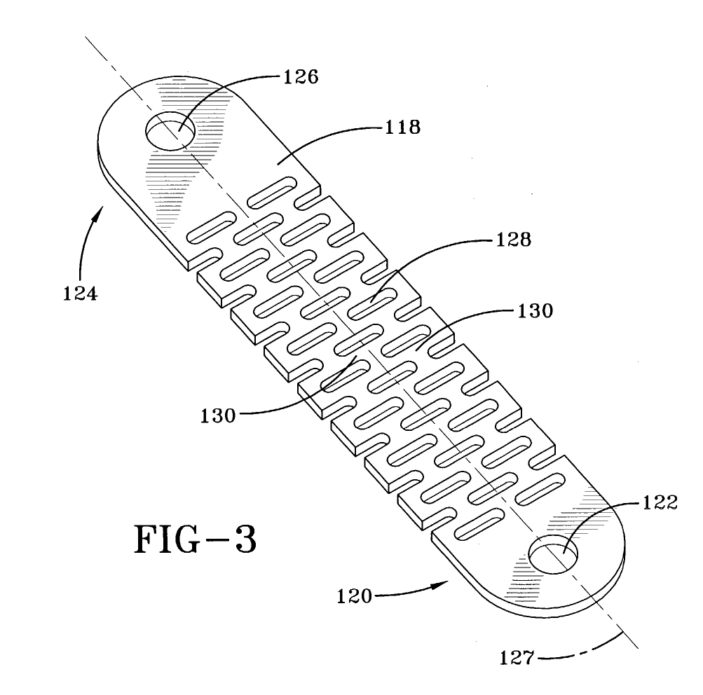

FIGS. 2 and 3 illustrate one form of load-limiting device 102 for the vehicle occupant restraint system. The load-limiting device 102 includes a Longitudinal strip 118 having a first end 120 with an opening 122 configured for connection to a vehicle occupant restraint and a second end 124 with an opening 126 configured for connection to a structural part of a vehicle. The opening 126 in the second end 124 enables the second end of the strip 118 to be connected to an anchor point on the vehicle (e.g. the B, C or D-pillar or seat), e.g. by a swaged threaded stud, a bolt or other type of connection. The opening 122 in the first end 120 is configured to enable the strip 118 to be connected to the web guide 112 of the vehicle occupant restraint (e.g. directly, in a manner similar to that shown in FIG. 1A).

The strip 118 has a longitudinal axis 127 that extends between the first and second ends 120,124. When a vehicle occupant loads the belt during a crash, forces F are applied to the strip 118, generally in the direction of the longitudinal axis 127 (see e.g. forces F in FIGS. 2B, 2C). The configuration of the strip 118 between the first and second ends 120, 124 enables plastic deformation of the strip 118 to occur when forces on the strip exceed the elastic limit of the strip.

The strip 118 is preferably formed of mild steel (e.g. 1010-1020 mild steel), and includes a pattern of perforations 128 extending between the first and second ends 120, 124 of the strip. Each perforation 128 preferably extends through the thickness of the strip 118.

As seen in FIGS. 2A-2C, the perforations 128 are formed in rows, each extending transverse to the longitudinal axis 127 of the strip. Moreover, as further seen in FIGS. 2A-2C, the perforations in adjacent rows are staggered relative to each other. Between adjacent rows of the perforations 128, the strip has solid portions 130 that extend transverse to the longitudinal axis 127, and those solid portions 130 effectively form bending beam-like segments disposed between the rows of perforations and extending transverse to the longitudinal axis 127. Before the strip is deformed, the bending beam like segments 130 have center lines 131 extending normal to the longitudinal axis 127 of the strip (see FIG. 2A). When the strip is deformed, the bending beam like segments 130 are deformed such that their center lines 131 extend generally transverse to the longitudinal axis 127 of the strip, but the segments 130 are bent in the manner schematically illustrated in FIGS. 2B and 2C.

It has been observed that with the foregoing structure, deformation of the strip 118 will begin in the bending beam like segments 130 in an intermediate portion of the strip 118, i.e. in bending beam like segments that are intermediate the rows of perforations that are closest to the ends 120, 124 of the strip 118. Once deformation of the strip begins the deformation propagates toward the ends 120, 124 of the strip. Thus, in FIGS. 2B and 2C, when forces F are applied to the strip 118, generally in opposite directions along the longitudinal axis 127, deformation of the bending beam like segments 130 begins in an intermediate portion of the strip and propagates toward the ends 120, 124 of the strip. FIG. 2B shows the center lines 131 of the bending beam like segments 130 as they start to deform, and FIG. 2C show the center lines of the bending beam like segments 130 as their deformation continues. As seen in FIG. 2B, the deformation of the bending beam like segments 131 begins in an intermediate portion of the strip (e.g. in the area schematically shown at C in FIG. 2A). The deformation propagates toward the ends of the strip, such that the deformation becomes greater in the intermediate portion C, and propagates toward the ends of the strip as shown in FIG. 2C.

The configuration of the perforations 128, the pattern of the rows of perforations 128, the spacing between the rows of perforations, and the bending characteristics of the beam-like segments 130 between the rows of perforations primarily determine the plastic deformation characteristics of the strip. The strip 118 of FIG. 3 has perforations 128 that are longer that the perforations of the strip of FIG. 2, and bending beam segments 130 that are accordingly different than the bending beam segments of FIG. 2, will have different deformation characteristics than the strip of FIG. 2. The manner in which the strip of FIG. 3 deforms will be generally the same as the manner in which the strip of FIG. 2 deforms, i.e. the deformation begins in the bending beam segments at an intermediate portion of the and propagates toward the ends of the strip.

Thus, when a load-limiting member of the type shown in FIG. 2 or 3 is used with a belt 104, at the onset of the crash, the retractor locks and prevents further belt payout, to provide a restraint on the vehicle occupant during the crash. As the vehicle occupant loads the belt (typically the shoulder belt) during the crash, forces applied to the strip 118 will be along the longitudinal axis 127 of the strip, in the direction of the forces F shown in FIGS. 2B-2C. Deformation of the strip will begin at an intermediate portion of the strip 118, and will propagate toward the ends 120, 124 of the strip (see e.g. FIGS. 2B and 2C). The load-limiting strip 118 will initially deform within its elastic limit, and then begin to deform plastically as the vehicle occupant continues to load the belt, and the strip 118 absorbs the forces applied to the belt by the vehicle occupant. Specifically, the beam like segments 130 between the rows of perforations will deform plastically, in the manner illustrated in FIGS. 2B-2C, to absorb the forces applied to the belt by the vehicle occupant.

The strip 118 can be formed by conventional metal forming techniques. While the perforations 128 are preferably openings that extend through the strip 118, the concept of perforations in the strip 118 is intended to encompass (a) openings that are formed in one piece with the strip 118 as the strip is formed, (b) slits that are cut or punched into (or through) the strip after the strip is formed, or (c) any other way of forming openings or recesses that extend at least partially through the strip, and provide a pattern of bending beam like segments in the strip that enable the strip to deform plastically, to dissipate the forces applied to a vehicle occupant during a crash. The concept of bending beam like segments is intended to describe segments of the strip that bend in the way illustrated by the center lines 131 in FIGS. 2B, 2C when sufficient load is applied to strip. Also, the concept of deformation of the strip beginning in an intermediate portion of the strip is intended to mean that deformation begins somewhere intermediate the portions of the perforated strip nearest the ends 120, 124 of the strip, and then propagates toward the ends of the strip.

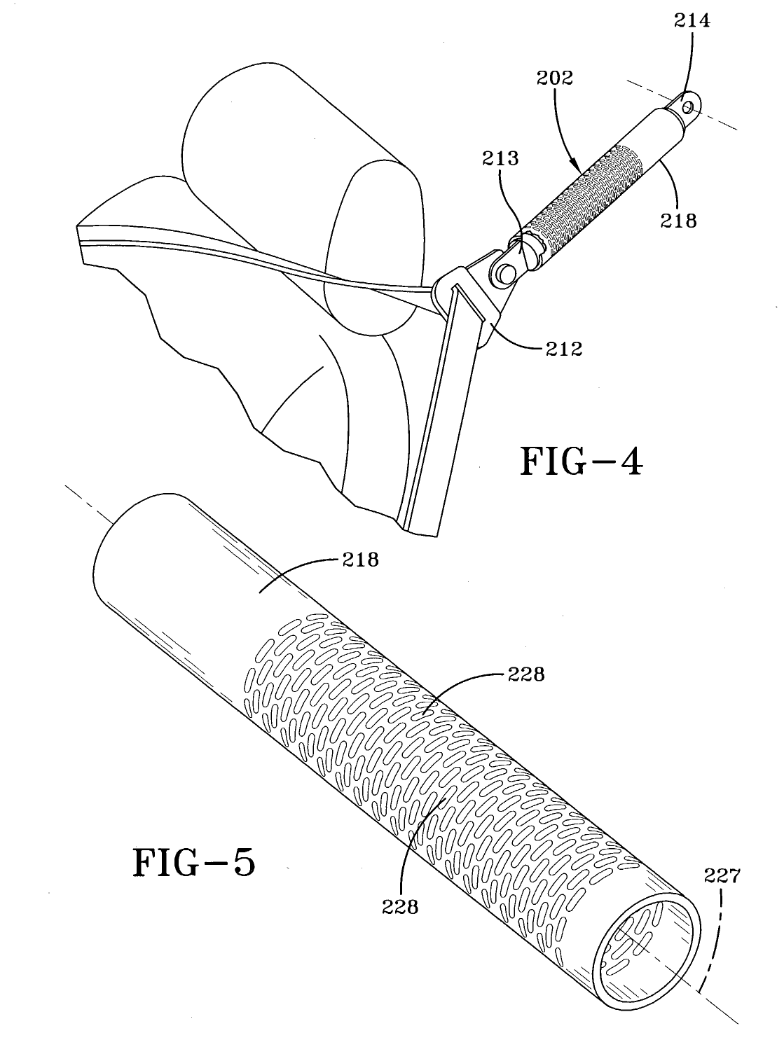

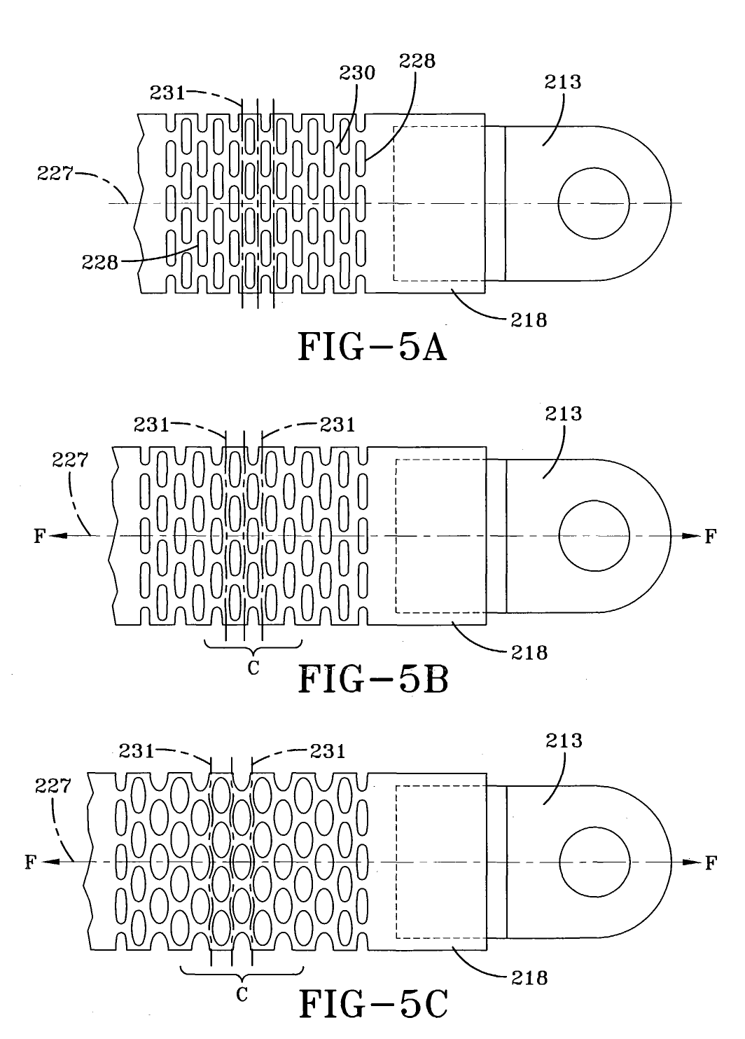

In the embodiment of the present invention illustrated in FIGS. 4, 5 and 5A-5C, the load-limiting device 202 is generally similar to the prior embodiment. However, in the embodiment of FIGS. 4, 5 and 5A-5C, the load limiting device 202 comprises a cylindrical tube 218 having a first end piece 213 configured to connect one end of the tube 218 to the web guide 212 of the vehicle occupant restraint. A second end piece 214 is configured to enable the other end of the tube 218 to be bolted or otherwise connected to an anchor point (e.g. the B-pillar or the vehicle seat). The tube 218 is formed of mild steel (e.g. type 1010 to 1020 mild steel). The configuration of the tube 218 between the first and second end pieces 213, 214 enables plastic deformation of the tube 218 to occur when forces on the tube exceed the elastic limit of the tube.

The tube 218 includes a predetermined pattern of perforations 228 disposed between the first and second end pieces 213, 214 of the tube. The tube 218 has a longitudinal central axis 227. The perforations 228 comprise rings (or partial rings) that extend around (or at least partially around) the longitudinal central axis 227, such that when the tube 218 is seen from a plan or elevational perspective (FIGS. 5A-5C), the rings of perforations 228 appear to extend transverse to the longitudinal central axis 227. The perforations 228 of each ring are in staggered relationship to each other, so that the annular solid portions 230 of the tube which are located between the rows of perforations 228 form beam like ring segments between the rings of perforations 228.

In the embodiment of FIGS. 4, 5, and 5A-5C, the tube 218 can be cast or otherwise formed by known metal forming techniques. The end pieces 213, 214 can be formed in one piece with the tube 218 (e.g. they can be cast in one piece with the tube), or they can be separately formed and coupled to the tube by known metal coupling techniques (e.g. by welding). The perforations 228 can be formed in one piece with the tube, as the tube is being formed, or they can be cut or punched through the tube (by known metal working techniques) after the tube is formed. The perforations 228 can also be formed by other techniques for forming openings or recesses that extend at least partially through the tube, and configure the tube to deform plastically, in accordance with the principles of the present invention, to dissipate the forces applied to a vehicle occupant during a crash.

As schematically illustrated in FIGS. 5A-5C, the manner in which the tube 228 deforms, to absorb forces applied to the belt 104 by a vehicle occupant is generally similar to the previous embodiment. Thus, at the onset of the crash, the retractor locks and prevents further belt payout, to provide a restraint on the vehicle occupant during the crash. As the vehicle occupant loads the belt during the crash, the load-limiting tube 218 may initially deform within its elastic limit, and depending on the level of the applied load will begin to deform plastically as the vehicle occupant continues to load the belt. As forces are applied in the directions F in FIGS. 5B, 5C, deformation will begin in the bending beam like ring segments in the intermediate portion of the tube (e.g. the area labeled C in FIGS. 5B, 5C, and will propagate toward the end pieces 213, 214 at the ends of the tube as the tube absorbs the forces applied to the belt by the vehicle occupant. The beam like ring segments 230 between the rows of perforations will deform plastically, in the manner illustrated in FIGS. 5B, 5C by their respective center lines 231, to absorb the forces applied to the belt by the vehicle occupant.

In each of the foregoing embodiments, there are certain features of the load-limiting device that allow the performance of the load-limiting device to be selectively designed (i.e. “tuned”) for a particular vehicle occupant restraint. Those features include the modulus of elasticity of the deformable member, the thickness of the deformable member, the geometry of the deformable member (e.g. the specific shapes of the perforations and the configurations of the rows or rings of perforations), and the material of the deformable member.

As used herein and in the claims “perforations” means openings extending completely through the strip or through the wall of the tube, regardless of how formed (e.g. molded, pierced, etc.), as well as recesses extending partially through the strip or tube, to provide the strip or tube with the capability to deform plastically to absorb forces applied to a belt system by a vehicle occupant during a crash.

A load-limiting device for a vehicle occupant restraint according to the present invention is designed to dissipate forces applied to the vehicle occupant in a predetermined manner during a crash. The design of the load-limiting device of the present invention provides significant flexibility in designing the predetermined manner in which the load-limiting device dissipates forces during a crash With the foregoing disclosure in mind, there will be other modifications and developments that will be apparent to those in the art.

1. An apparatus comprising a load limiting device configured for use with a vehicle safety restraint system, the load limiting device comprising a longitudinal member having spaced portions configured for connection with a vehicle safety restraint and a vehicle anchor point, respectively, so that forces applied to the safety restraint are applied to the longitudinal member, and the longitudinal member being plastically deformable in a predetermined manner when forces on the longitudinal member exceed the elastic limit of the longitudinal member.

2. The apparatus of claim 1, wherein the longitudinal member comprises a strip having a first end configured for connection to a vehicle occupant restraint and a second end configured for connection to the anchor point, the configuration of the strip between the first and second ends providing plastic deformation of the strip in a predetermined manner when forces on the strip exceed the elastic limit of the strip.

3. The apparatus of claim 2, wherein the longitudinal strip includes a predetermined pattern of perforations extending between the first and second ends of the strip, each perforation having a predetermined configuration, the pattern of the perforations and the configurations of the perforations providing the strip with its plastic deformation characteristics.

4. The apparatus of claim 3, wherein the longitudinal strip has a longitudinal axis and the perforations are formed in rows that extend transverse to the longitudinal axis of the longitudinal strip.

5. The apparatus of claim 4, wherein the perforations in each row are in staggered relation to the perforations of an adjacent row.

6. The apparatus of claim 5, wherein the longitudinal strip has solid portions between staggered rows of perforations and define beam-like segments between the rows of perforations, the beam like segments extending transverse to the longitudinal axis of the strip.

7. The apparatus of claim 6, wherein the longitudinal strip is formed of mild steel.

8. The apparatus of claim 3, wherein the pattern of the perforations causes deformation of the strip to be initiated at an intermediate portion of the strip and enables the deformation to propagate toward the ends of the strip.

9. The apparatus of claim 3, wherein the shape of the perforations and the pattern of the perforations create beam like segments in the strip, the beam like segments extending transverse to the longitudinal axis of the strip.

10. The apparatus of claim 1, wherein the longitudinal member comprises a tube having a first end configured for connection to a vehicle occupant restraint and a second end configured for connection to an anchor point of a vehicle, the configuration of the tube between the first and second ends providing plastic deformation of the tube in a predetermined manner when forces on the tube exceed the elastic limit of the tube.

11. The apparatus of claim 10, wherein the tube includes a predetermined pattern of perforations, wherein each perforation has a predetermined configuration, and wherein the pattern of the perforations and the configurations of the perforations provide the tube with its plastic deformation characteristics.

12. The apparatus of claim 11, wherein the longitudinal tube has a central axis, and the perforations comprise rings extending at least partially about the central axis of the longitudinal tube.

13. The apparatus of claim 12, wherein the perforations in each ring are staggered relative to the perforations of the adjacent ring.

14. The apparatus of claim 13, wherein the staggered rings of perforations define beam like ring segments between the rows of perforations, the beam like ring segments extending at least partially about the central axis of the longitudinal tube.

15. The apparatus of claim 14, wherein the longitudinal tube is formed of mild steel.

16. The apparatus of claim 13, wherein the pattern of the perforations causes deformation of the tube to be initiated in the ring like segments at an intermediate portion of the tube and enables the deformation to propagates longitudinally along the tube.

17. The apparatus of claim 13, wherein the shape of the perforations and the pattern of the perforations create beam like ring segments in the tube, the beam like ring segments extending at least partially about the longitudinal central axis of the tube.
